(19) United States
(12) Patent Application Publication
(10) Pub. No.: US 2017/0100794 A1
(43) Pub. Date: Apr. 13, 2017

(54) LASER SOLDERING PROCESS

(71) Applicant: TYCO ELECTRONICS CORPORATION, Berwyn, PA (US)

(72) Inventors: Huadong WU, Hershey, PA (US); Sara Elizabeth BOLHA, Harrisburg, PA (US); Yasser M. ELDEEB, Harrisburg, PA (US)

(21) Appl. No.: 14/879,479

(22) Filed: Oct. 9, 2015

(51) Int. Cl. B23K 1/005; B23K 26/06; B23K 26/32

(52) U.S. Cl. CPC B23K 1/0056; B23K 26/32; B23K 26/06

(57) ABSTRACT

Laser soldering processes are disclosed. The laser soldering process includes beaming a lower-intensity laser beam from a laser soldering system at a first position, analyzing infrared feedback of the lower-intensity laser beam at the first position, and beaming a higher-intensity laser beam at a second position, the second position corresponding with the infrared feedback of the lower-intensity laser beam. The lower-intensity laser beam generates a lower temperature below a soldering temperature of a solder material and the higher-intensity laser beam generates a higher temperature above the soldering temperature.

### FIELD OF THE INVENTION

The present invention is directed to manufacturing and industrial processes. More particularly, the present invention is directed to laser soldering processes.

### BACKGROUND OF THE INVENTION

Commercial use of lasers for soldering has been tried in the past. However, many individuals skilled in the art believe that lasers are incapable of achieving the technical requirements for soldering in certain applications. For example, prior attempts to use laser soldering have been on the scale of soldering materials used in components, such as, wires, conductors, and strands having diameters or cross section widths of at least 0.5 millimeters and termination base components, such as copper traces or pads in printed circuit boards having widths of at least 0.5 millimeters and thicknesses of 0.5 millimeters.

Laser soldering has technical complications. Laser soldering does not involve physical contact. Although there are beneficial aspects of being devoid of physical contact, being devoid of physical contact can induce vertical overhang defects in solder joints, compared to traditional hot-iron tip soldering, thus producing soldering defects that adversely affect quality and effectively limit soldering precision.

Laser soldering processes that show one or more improvements in comparison to the prior art would be desirable in the art.

### BRIEF DESCRIPTION OF THE INVENTION

In an embodiment, a laser soldering process includes beaming a lower-intensity laser beam from a laser soldering system at a first position, analyzing infrared feedback of the lower-intensity laser beam at the first position, and beaming a higher-intensity laser beam at a second position, the second position corresponding with the infrared feedback of the lower-intensity laser beam. The lower-intensity laser beam generates a lower temperature below a soldering temperature of a solder material and the higher-intensity laser beam generates a higher temperature above the soldering temperature.

In another embodiment, a laser soldering process includes beaming a lower-intensity laser beam from a laser soldering system at a first position, then analyzing infrared feedback of the lower-intensity laser beam at the first position using an infrared and visible light sensing camera, then repositioning one or more of the laser soldering system, a first conductive member coated with a solder material to be soldered, and a second conductive member coated with the solder material, and then beaming a higher-intensity laser beam from the laser soldering system to one or both of the first conductive member and the second conductive member at a second position determined in response to the analyzing, the second position differing from the first position. The lower-intensity laser beam generates a lower temperature below a soldering temperature of the solder material and the higher-intensity laser beam generates a higher temperature above the soldering temperature.

In another embodiment, a laser soldering process includes beaming a lower-intensity laser beam from a laser soldering system at a first position, then analyzing infrared feedback of the lower-intensity laser beam at the first position, and then beaming a higher-intensity laser beam at a second position, the second position corresponding with the infrared feedback of the lower-intensity laser beam. The lower-intensity laser beam generates a lower temperature below a soldering temperature of a solder material and the higher-intensity laser beam generates a higher temperature above the soldering temperature. The beaming of the higher-intensity laser beam is through an elongate slit having a first dimension and a second dimension defining an aperture of the elongate slit, the first dimension being less than 0.05 millimeters and the second dimension is between 0.7 millimeters and 1.1 millimeters.

Other features and advantages of the present invention will be apparent from the following more detailed description, taken in conjunction with the accompanying drawings which illustrate, by way of example, the principles of the invention.

### BRIEF DESCRIPTION OF THE DRAWINGS

FIG. 1 is a schematic view of an embodiment of a laser soldering process, according to the disclosure.

FIG. 2 is a perspective view of an embodiment of a laser soldering process with an elongate slit positioned to adjust the geometry of a laser beam, according to the disclosure.

Wherever possible, the same reference numbers will be used throughout the drawings to represent the same parts.

### DETAILED DESCRIPTION OF THE INVENTION

Provided are laser soldering processes. Embodiments of the present disclosure, for example, in comparison to concepts failing to include one or more of the features disclosed herein may provide one or more of the following benefits, including, but not limited to: i) use of lasers for precise (for example, having tightly-controlled temperatures) and high-quality soldering on materials having dimensions (for example, size, pitch, and/or thickness) as small as 0.05 millimeters; ii) reduce or eliminate uneven heating previously believed to be a feature of laser soldering; iii) reduce or eliminate unintended burning of solder; iv) reduce or eliminate thermal damage to heat-sensitive components during manufacturing (for example, of components that receive thermal damage when exposed to temperatures of greater than 343° C.); v) reduce or eliminate vertical overhang defects in solder joints; vi) allow for more precise soldering; vii) allow laser soldering operation which are devoid of mirrors, including, but not limited to moving mirrors; and/or viii) any suitable combination thereof.

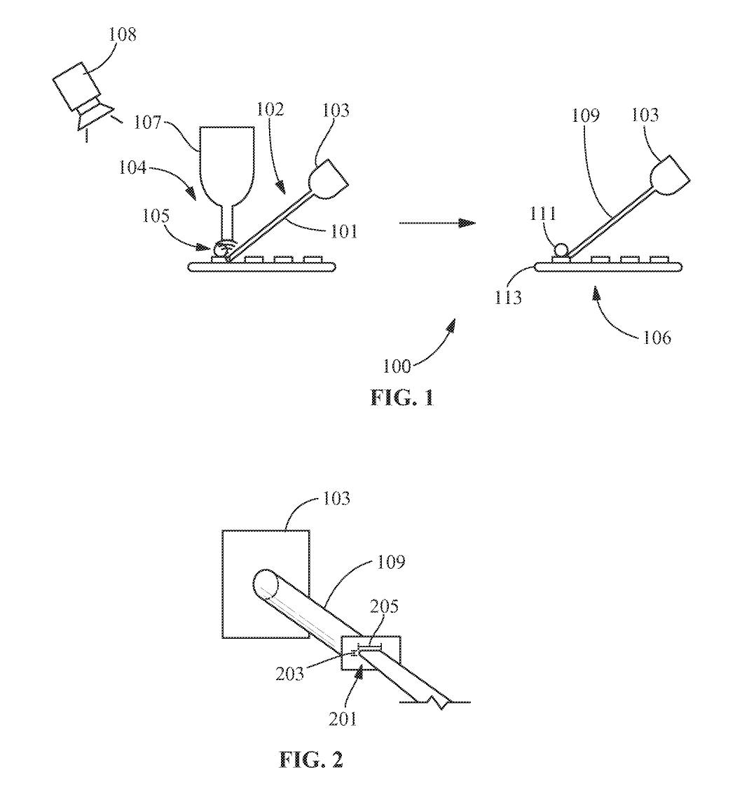

FIG. 1 shows an embodiment of a laser soldering process 100. The laser soldering process 100 includes a first or initial step of beaming a lower-intensity laser beam 101 (step 102). The infrared laser reflection or feedback of the lower-intensity laser beam 101 in relation to components is analyzed, either directly or indirectly (step 104) (for example, using a computer vision system with long focal length camera 108 capable of sensing infrared and visible light from a long distance). Based on the feedback, the lower-intensity laser beam 101 is adjusted to fine-tune its position and incident angle, resulting in the lower-intensity laser beam 101 being moved to a second position. Once the lower-intensity laser beam 101 has been properly adjusted, the higher-intensity laser beam 109 is beamed (step 106) at the same position with the same incident angle, such that the higher-intensity laser beam corresponds with the infrared feedback of the lower-intensity laser beam. The lower-intensity laser beam 101 generates a lower temperature below the soldering temperature of the solder material coated on a first conductive member 111, such as a conductive pre-tinned wire, such that the solder material is not melted until the beam is properly adjusted. In contrast, the higher-intensity laser beam 109 has an intensity resulting in a temperature above the soldering temperature threshold with an experimentally pre-determined intensity-over-time profile which generates a higher temperature above the soldering temperature, thereby allowing the beam 109 to melt the solder when the higher-intensity laser beam 109 is positioned at the optimum position to ensure proper solder material to reflow to reform a high-quality bonding.

Alternatively to or in addition to the position and incident angle of the lower-intensity laser beam being moved or adjusted, based on the feedback received from infrared laser reflection in relation to components, the first conductive member 111 to be soldered and/or the conductive substrate or second conductive member 113 may be repositioned to provide the desired benefits as described above.

As stated above, the infrared laser reflection in relation to components is analyzed, either directly or indirectly (step 104) to determine the properties of the solder material on the first conductive member 111 and the second conductive member 113 (for example, using a computer vision system with long focal length camera 108 capable of sensing infrared and visible light from a long distance). According to an illustrative embodiment of the invention, the properties of the second conductive member 113 (which may include, but are not limited to wires, conductors, strands, termination pads or traces), including the properties of the solder material coated on the second conductive member 113, and the properties of the first conductive member 111 (which may include, but are not limited to, status [geometrical size and shape, pre-tinned conditions etc.] and optical reflection characteristics, including the properties of the solder material coated on the first conductive member 111, are analyzed. In various illustrative embodiments, the solder material is applied directly to the first conductive member 111 and the second conductive member 113 prior to the soldering process 100 described herein.

As stated above, based on the information collected during the analysis, the position of the lower-intensity laser beam 101 is adjusted to fine-tune its position and incident angle of the lower-intensity laser beam, resulting in the lower-intensity laser beam 101 being moved to a second position. In so doing, an appropriate near-infrared laser source is selected to perform the soldering process. A series of experiments or trials are then performed in variation of laser beam power intensity over selected time durations to form a laser beam power intensity profile. The laser beam power intensity profile is optimized to achieve high soldering quality for the specific soldering tasks, i.e. ensuring for proper solder material reflow to reform a high-quality bonding.

In one embodiment, the higher-intensity laser beam 109 of the laser soldering process 100 melts the solder material on the first conductive member 111 (for example, a copper material conductor) and the second conductive member 113 (such as, but not limited to, a termination pad and/or copper trace on a flexible printed circuit board or substrate 115) during the beaming of the higher-intensity beam (step 106). Upon being soldered, the first conductive member 111 is bonded onto and connected to the second conductive member 113. The first conductive member 111 and the second conductive member 113 are any suitable conductive materials capable of being soldered with the solder material by conventional hot-iron tip soldering processes. Such suitable soldering conductive materials have low thermal impact and are capable of achieving high precision solder joints. Suitable conductive materials include, but are not limited to, metals (for example, copper, silver, nickel, or gold), metallic materials (for example, cupric materials), and alloys (for example, copper-nickel alloys).

The first conductive member 111 can have any suitable physical dimensions, depending upon the desired signal or power conducting application. Such suitable physical dimensions include, but are not limited to, thicknesses/diameters of less than 0.3 millimeters (AWG 30), less than 0.2 millimeters (AWG 32), less than 0.1 millimeters (AWG 38), between 0.09 millimeters (AWG 39) and 0.05 millimeters (AWG 44), or any suitable combination, sub-combination, range, or sub-range therein.

In the illustrative embodiment shown, the second conductive member 113 is a rigid or flexible material composite structure with traces made of compatible material with the solder material on the first conductive member 111. Examples include, small and thin conductive printed metallic circuit traces/pads on a substrate or printed circuit board 115. In one illustrative embodiment, the second conductive member 113 is copper base conductive metallic alloy trace pads bonded onto a flexible material, for example, a polyimide material substrate. The second conductive member 113 has a thickness depending upon the materials and arrangement utilized. Suitable thicknesses of the conductive member include, but are not limited to, 0.5 millimeters (for example, IPC L4) and 0.2 millimeters (for example, IPC L4), 0.15 millimeters (for example, IPC L3), 0.10 millimeters (for example, IPC L2), 0.05 millimeters (for example, IPC L1), or any suitable combination, sub-combination, range, or sub-range therein.

In one embodiment, the second conductive member 113 extends to double sides/planes, for example, conductive traces on a thin polymer material substrate of about 0.04 millimeter thick. In another embodiment, the second conductive member 113 includes circuitry conductors printed directly on a rigid composite laminate bulk material, such as, reinforcing cloth threads fiber weave with impregnating resins, which are capable of operating in higher thermal stress environments than thin polymers.

The properties of the solder material on the first conductive member 111 and/or the second conductive member 113 (for example, the pre-tinned condition/status of the second conductive member 113) are compatible with the laser soldering process 100. For example, in one embodiment, the laser soldering process 100 maintains a temperature range below a material-damaging temperature for the second conductive member 113 and/or the substrate or printed circuit board 115, such as by maintaining a temperature of below 343° C., 320° C., 300° C., or any suitable combination, sub-combination, range, or sub-range therein, and above a soldering temperature. In one embodiment, the temperature range of the second conductive member 113 is between 140° C. and 178° C., between 140° C. and 180° C., between 140° C. and 178° C., between 153° C. and 198° C., or any suitable combination, sub-combination, range, or sub-range therein. The temperature range of the second conductive member 113 is maintained for a certain duration to permit reflow, for example, of tin-bismuth solder material to produce a bonding structure.

In one embodiment, the lower-intensity laser beam 101 and/or the higher-intensity laser beam 109 are at an angle A (for example, between 15 degrees and 75 degrees) relative to the second conductive member 113 and/or the first conductive member 111. The positioning of the higher-intensity laser beam 109, as previously described, permits concurrent and/or substantially uniform heating of multiple portions, such as, both the second conductive member 113 and the first conductive member 111.

The geometric structure and dimensions of the second conductive member 113, the substrate 115 upon which the second conductive member 113 is positioned, the first conductive member 111, and/or their relative positions are compatible with the laser soldering process 100. For example, in one illustrative embodiment, the total thickness of the second conductive member 113 and/or substrate 115 is 0.051 millimeters, in which the second conductive member 113 is a double-sided component having printed circuitry traces with pitch as narrow as 0.1 millimeters and circuitry trace and pad width as narrow as 0.051 millimeters, the second conductive member 113 having a complex geometric structure and very fine scale dimensions which causes soldered components to be venerable to thermal stress damage. Accordingly, the laser soldering process 100 is designed to accurately control the laser beam location, the laser beam incident angle A, and the laser beam power intensity profile such that the resulting peak temperature of the second conductive member 113 and the substrate 115 has large safety margin below the second conductive member 113 and the substrate 115 maximal allowable temperature and, ideally, bellow a maximum 260° C. working temperature to prevent degradation of the second conductive member 113 and/or the substrate 115. Stated differently, laser power intensity of the higher-intensity laser beam 109 is controlled to ensure that given the thickness of the second conductive member 113 and/or substrate 115 is greater than a suitable thickness that prevents thermal degradation of the second conductive member 113 and/or substrate 115.

The laser soldering process 100 has several advantages, including, but not limited to those discussed above. The beaming of the lower-intensity laser beam 101 (step 102) at a first position and analyzing of the lower-intensity laser beam 101 reflection characteristics proximal to the solder material on the first conductive member 111 and the second conductive member 113 (step 104) provides increased monitoring of laser beam heating-up and light reflection properties. Once the data obtained from the analysis is complete, the experimental set-up of a laser power intensity profile that extrapolates and/or interpolates heating characteristics for select soldering applications is developed, as previously described.

In one embodiment, an infrared remote temperature measuring device 107 is positioned to analyze the temperature of the second conductive member 113 and/or the first conductive member 111, and provides real-time feedback and/or data (step 104). For example, the date may be used to contribute to the laser beam power intensity profile used to optimize the beaming of the higher-intensity laser beam 109 (step 106). Such real-time feedback is capable of providing additional process control thus preventing thermal impact damage that could otherwise be induced by intrinsic temperature fluctuation characteristics during solder reflow, which can drastically cause variation of laser beam reflection and absorption.

As will be appreciated by those skilled in the art, other embodiments encompass utilizing corresponding systems and techniques, such as, advanced robotic force feedback control technology to manipulate and align conductor leads/wires accurately to their corresponding solder pad traces and/or to maintain a desired pressure force on the wires to hold the wires on the pad traces. Such additional techniques are capable of collaborating with the computer vision data provided from the scene analyzing (step 104).

The beaming of the higher-intensity laser beam 109 (step 106), for example, from the laser soldering system 103, solders the first conductive member 111 onto the second conductive member 113. The optimization of the beaming intensity profile of the higher-intensity laser beam 109 (step 106) is determined in response to infrared feedback 105 (step 104) of the lower-intensity laser beam 101, with or without real-time feedback from an additional infrared remote temperature sensing device 107 (step 104). Alternatively, a predetermined operational or intensity profile may be used to optimize the higher-intensity laser beam 109 (step 106). The predetermined operational profile may be developed using data which has been developed over time, may be developed using other computer modeling, or by other know methods.

In one embodiment, the predetermined intensity profile adjusts the intensity of the higher-intensity laser bream within an intensity range defined through correlating experimental results with nominal control signals of the laser soldering system, for example, but not limited to, the operational profile is developed from data determined through the analyzing of the lower-intensity laser beam 101 (step 104) correlated with the location and incident angle of the higher-intensity laser beam 109, in which laser source exciting current is operated at any suitable varying intensity and/or any suitable varying pulse duration. Based upon the laser source being used, suitable varying intensities or intensity profiles include, but are not limited to, an intensity range of between 5 amps and 10 amps (for example, for lower-intensity location, incident angle, and pre-heating profiling experiments), an intensity range of between 10 amps and 15 amps (for example, for ultra-fine soldering applications), an intensity range of between 15 amps and 25 amps (for example, for medium-fine soldering applications), an intensity range of above 25 amps (for example, for fine and ordinary soldering applications), or any suitable combination, sub-combination, range, or sub-range therein.

In one embodiment, the laser soldering process 100 includes iteratively repositioning the laser soldering system 103 after the beaming of the lower-intensity laser beam 101 (step 102) and before the beaming of the higher-intensity laser beam 109 (step 106). Additionally or alternatively, in one embodiment, the relative position of the first conductive member 111 and the second conductive member 113 are adjusted or iteratively repositioned in response to the computer vision scene analyzing (step 104), where the beaming of the lower-intensity laser beam 101 (step 102) is before the beaming of the higher-intensity laser beam 109 (step 106).

In one embodiment, the lower-intensity laser beam at the first position is parallel with the higher-intensity laser beam at the second position.

Referring to FIG. 2, in one embodiment, the beaming of the lower-intensity laser beam 101 (step 102) and/or the beaming of the higher-intensity laser beam 109 (step 106) is through an elongate slit 201. The elongate slit 201 has a first dimension 203 and a second dimension 205 defining an aperture of the elongate slit 201 that, for example, corresponds or is proportional with the dimensions of the first conductive member 111 being soldered. Alternatively, the first dimension 203 and the second dimension 205 of the elongate slit 201 may correspond or be proportional with the dimensions of the second conductive member 113. The first dimension 203 of the elongate slit 201 is smaller than the second dimension 205 of the elongate slit 201. In one embodiment, the first dimension 203 is less than 0.05 millimeters and/or has a thickness consistent with the width of the first conductive member 111 or the width of the second conductive member 113. Additionally or alternatively, in one embodiment, the second dimension is between 0.7 millimeters and 1.1 millimeters consistent with the length of the solder material 111 or the length of the second conductive member 113.

While the invention has been described with reference to one or more embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. In addition, all numerical values identified in the detailed description shall be interpreted as though the precise and approximate values are both expressly identified.

What is claimed is:

1. A laser soldering process, comprising:
beaming a lower-intensity laser beam from a laser soldering system at a first position;
analyzing infrared feedback of the lower-intensity laser beam at the first position; and
beaming a higher-intensity laser beam at a second position, the second position corresponding with the infrared feedback of the lower-intensity laser beam;
wherein the lower-intensity laser beam generates a lower temperature below a soldering temperature of a solder material and the higher-intensity laser beam generates a higher temperature above the soldering temperature.

2. The laser soldering process of claim 1, wherein the beaming of the higher-intensity laser beam has a predetermined intensity profile.

3. The laser soldering process of claim 2, wherein the predetermined intensity profile corresponds with data identified through the analyzing of the infrared feedback.

4. The laser soldering process of claim 2, wherein the predetermined intensity profile corresponds with the angular position of the higher-intensity laser beam.

5. The laser soldering process of claim 2, wherein the predetermined intensity profile adjusts the intensity of the higher-intensity laser beam within an intensity range defined through correlating experimental results with nominal control signals of the laser soldering system.

6. The laser soldering process of claim 1, wherein the first position differs from the second position.

7. The laser soldering process of claim 6, comprising iteratively repositioning the laser soldering system after the beaming of the lower-intensity laser beam and before the beaming of the higher-intensity laser beam to reflow a soldering material.

8. The laser soldering process of claim 6, comprising iteratively repositioning a first conductive member being soldered relative to the second conductive member after the beaming of the lower-intensity laser beam and before the beaming of the higher-intensity laser beam in response to feedback from the analyzing.

9. The laser soldering process of claim 6, wherein the lower-intensity laser beam at the first position is parallel with the higher-intensity laser beam at the second position.

10. The laser soldering process of claim 1, wherein the first position is the same as the second position.

11. The laser soldering process of claim 1, wherein the beaming of the higher-intensity beam solders a first conductive member to a second conductive member.

12. The laser soldering process of claim 11, wherein the conductive member is on a substrate, the substrate and the conductive member having a combined thickness of between 0.01 millimeters and 0.06 millimeters.

13. The laser soldering process of claim 1, wherein the beaming of the higher-intensity laser beam is from the laser soldering system.

14. The laser soldering process of claim 1, wherein the beaming of one or both of the lower-intensity laser beam and the higher-intensity laser beam is through an elongate slit having a first dimension and a second dimension defining an aperture of the elongate slit, the first dimension being smaller than the second dimension.

15. The laser soldering process of claim 14, wherein the first dimension is less than 0.05 millimeters.

16. The laser soldering process of claim 14, wherein the second dimension is between 0.7 millimeters and 1.1 millimeters.

17. The laser soldering process of claim 1, wherein a single laser source is used to generate the beaming of the higher-intensity laser beam and the lower-intensity laser beam and wherein the laser soldering system is devoid of moving mirrors in an optical transmission path used for forming a laser light heating field or profile.

18. The laser soldering process of claim 1, wherein the analyzing of the infrared feedback utilizes computer vision technology.

19. A laser soldering process, comprising:
beaming a lower-intensity laser beam from a laser soldering system at a first position; then
analyzing infrared feedback of the lower-intensity laser beam at the first position using an infrared and visible light sensing camera; then
repositioning one or more of the laser soldering system, a first conductive member coated with a solder material to be soldered, and a second conducive member coated with the solder material; and then
beaming a higher-intensity laser beam from the laser soldering system to one or both of the first conductive member and the second conductive member at a second position determined in response to the analyzing, the second position differing from the first position;
wherein the lower-intensity laser beam generates a lower temperature below a soldering temperature of the solder material on the first conductive member and the second conductive member and the higher-intensity laser beam generates a higher temperature above the soldering temperature.

20. A laser soldering process, comprising:
beaming a lower-intensity laser beam from a laser soldering system at a first position; then
analyzing infrared feedback of the lower-intensity laser beam at the first position; and then
beaming a higher-intensity laser beam at a second position, the second position corresponding with the infrared feedback of the lower-intensity laser beam;
wherein the lower-intensity laser beam generates a lower temperature below a soldering temperature of a solder material and the higher-intensity laser beam generates a higher temperature above the soldering temperature;
wherein the beaming of the higher-intensity laser beam is through an elongate slit having a first dimension and a second dimension defining an aperture of the elongate slit, the first dimension being less than 0.05 millimeters and the second dimension is between 0.7 millimeters and 1.1 millimeters.
